(19) United States
(12) Patent Application Publication
(10) Pub. No.: US 2009/0157456 A1
(43) Pub. Date: Jun. 18, 2009

(54) SYSTEM AND METHOD FOR PROVIDING FORMS AND DISCLOSURES ADVICE

(76) Inventor: Joshua D.J. Sharfman, Los Angeles, CA (US)

Correspondence Address: CHRISTIE, PARKER & HALE, LLP, PO BOX 7068, PASADENA, CA, 91109-7068, US

(21) Appl. No.: 12/257,343

(22) Filed: Oct. 23, 2008

Related U.S. Application Data
(60) Provisional application No. 61/000,206, filed on Oct. 23, 2007.

(51) Int. Cl. G06Q 99/00; G06F 7/00; G06Q 10/00; G06Q 50/00

(52) U.S. Cl. 705/7; 705/1; 715/226

(57) ABSTRACT

A system and a method for providing advice on selecting and completing different forms and disclosures are provided. Applicable information is collected. Forms and disclosures are determined based on the information collected. The forms and disclosures are selected from collections of forms and disclosures provided by the federal government, state governments, local municipalities, and/or other sources. Various different types of advice associated with the selected forms and disclosures are also provided.

### CROSS-REFERENCE TO RELATED APPLICATION(S)

The present application claims the benefit and priority of Provisional Patent Application Ser. No. 61/000,206, filed Oct. 23, 2007.

### BACKGROUND OF THE INVENTION

1. Field of the Invention

The present invention relates to a system and a method for providing different types of advice associated with different forms and disclosures.

2. Description of Related Art

Different forms and disclosures are used in various different situations and/or scenarios. For example, when conducting a transaction, such as a real estate transaction, real estate agents must determine the proper real estate forms to use and disclosures to make. Determining the proper real estate forms to use and disclosures to make can be complicated, as federal and state laws, as well as local ordinances, mandate that particular forms be used and that particular disclosures be made depending on the real estate transaction. For example, pursuant to federal law, if a property was constructed prior to 1978, sellers must disclose known information on potential lead-based paint and lead-based paint hazards before selling a house, and thus sales contracts must include a disclosure about lead based paint. Many of these rules and laws are modified over time, such that it may be difficult to keep up with the most current rules sets and apply the appropriate forms and/or disclosures in various scenarios. In addition, different stages of a process may require the application of different forms and/or disclosures. For example, a first set of forms may be suggested or required at a first phase or stage of a particular transaction, and a second set of forms may be suggested or required at a later stage or phase of that transaction. Furthermore, there may be certain best practices to use and specific forms most appropriate in various different situations. In general, the nature of the relationship between the client and real estate professional, information about the clients, information about the property, and information about the nature of the transaction, among other factors, dictate the use of different forms or the making of particular disclosures.

Thus, real estate agents have a complex set of issues to consider in determining the proper real estate forms to use and the disclosures to make in a particular real estate transaction. If real estate agents use the wrong forms or fail to make the proper disclosures when a federal or state statute mandates that a particular form be used or that a particular disclosure be made, they could be opening themselves up to liability directly or indirectly by creating liability for their clients.

Conventional methods to educate real estate agents on the proper forms to use and the disclosures to make at various stages of particular transactions include checklists and training sessions. Unfortunately, real estate agents cannot always remember which forms to use, for example, selecting from among the more than 150 potentially applicable or useful proprietary forms provided by the California Association of Realtors alone for the state of California, when conducting a particular real estate transaction. Further, there are additional forms as required for different federal laws, brokers, and particular municipalities, as well as various third party forms which may also be applicable or useful.

### SUMMARY OF THE INVENTION

A system and method for providing advice associated with different forms and disclosures are provided. In one aspect, a method for providing advice on selecting and completing forms and disclosures is provided, including: collecting information from a user; selecting forms and disclosures based on a plurality of rules and the information collected; and providing advice on the selected forms and disclosures.

In another aspect, a method for providing advice on real estate forms and disclosures for a real estate transaction is provided, including: obtaining information related to the real estate transaction from a multiple listing service, a public record database, an electronic forms system, an electronic transaction management system, or one or more third party sources; collecting information related to the real estate transaction from a user; processing a plurality of rules in accordance with the obtained and collected information to determine appropriate real estate forms and disclosures to select for the transaction from a plurality of real estate forms and disclosures from at least one of the federal government, state governments, local municipalities, brokers, or at least one of the one or more third party sources; providing a list of the selected real estate forms and disclosures for the real estate transaction; providing the selected real estate forms and disclosures for the real estate transaction for download; and automatically filling out portions of the downloadable real estate forms or disclosures in accordance with the obtained and collected information.

In yet another aspect, a system for providing advice on selecting and completing forms and disclosures is provided, the system including a memory including program instructions and a processor, the processor configured by the program instructions to: collect information from a user; select forms and disclosures based on a plurality of rules and the information collected; and provide advice on the selected forms and disclosures.

### BRIEF DESCRIPTION OF THE DRAWINGS

FIGS. 1A and 1B are screenshots of an exemplary product into which the real estate forms and disclosures advice system may be integrated in accordance with aspects of the invention.

FIG. 2 is a new transaction screen in accordance with aspects of the invention.

FIG. 3 is a flow diagram illustrating a typical operation process of an exemplary embodiment of the forms and disclosures advice system in accordance with aspects of the invention.

FIG. 4 is a screenshot of an initial screen of a real estate purchase questionnaire in a forms and disclosures advice system in accordance with aspects of the invention.

FIGS. 5A and 5B are additional screenshots of the initial screen in accordance with aspects of the invention.

FIG. 6 is a screenshot showing questions associated with general property information about a real estate transaction in accordance with aspects of the invention.

FIG. 7 is a screenshot showing questions and user answers to client related information regarding a real estate transaction in accordance with aspects of the invention.

FIG. 8 is a screenshot showing questions and user answers to transactional information regarding a real estate transaction in accordance with aspects of the invention.

FIG. 9 is a flow diagram illustrating a process of determining appropriate forms to use for a particular transaction in accordance with aspects of the invention.

FIG. 10 is an example of a screenshot of a first summary page in a forms and disclosures advice system in accordance with aspects of the invention.

FIG. 11 is an example of a screenshot summarizing advice provided as a result of answers and other information provided in questionnaires of the forms and disclosures advice system in accordance with aspects of the invention.

FIGS. 12A and 12B illustrate examples of different notifications which may be associated with particular forms selected by the forms and disclosures advice system in accordance with aspects of the invention.

FIGS. 13A and 13B are screenshots of a second embodiment of the forms and disclosures advice system in accordance with aspects of the invention.

FIGS. 14A and 14B are additional screenshots of the second embodiment of the forms and disclosures advice system in accordance with aspects of the invention.

### DETAILED DESCRIPTION

The forms and disclosures advice system allows a user or agent of the user to enter different types of information. In some embodiments, the information may include information about a particular transaction, such as a real estate transaction, and obtain various types of advice about which forms to use or disclosures to make for the particular transaction. For example, for real estate transactions, the advice provided by the system is based on information about the property, the transaction, the principals, and the relationship between the agent and principals, among other factors. It is to be understood that in the following description, a transaction may refer to a business transaction, for example, a real estate transaction or a product-based transaction, but should not be limited thereto. For example, a transaction may also refer more generally to any interaction or situation in which different forms or disclosures may be utilized, or to any situation in which different tasks are to be executed. In an exemplary embodiment, the system also provides previews of different forms and disclosures, advice about how to fill out the forms and disclosures, at what stages in a particular transaction to use the forms and disclosures, and to whom and by whom the forms and the disclosures should be presented. In another exemplary embodiment, the system provides a template that defines what forms should be used for a given class of transactions. In another exemplary embodiment, the system identifies situations in which no forms are available, or where only some forms are available, and provides guidance and/or suggestions to the user, for example, to seek legal counsel in those particular situations. In yet another exemplary embodiment, the system also provides educational instructions related to the forms, disclosures, or transaction, as well as the correct times to apply or implement the forms and/or disclosures during the transactions. In a further exemplary embodiment, the system also retrieves the proper forms and disclosures and fills out parts of the forms and disclosures based on answers to previously presented questions to help facilitate the transaction. The system may be updated, such that the correct forms and disclosures are retrieved in light of possible recent law or rules changes. In yet another exemplary embodiment, the system may obtain at least some of the information about the property and the real estate transaction from the multiple listing service (MLS), public record databases, an electronic forms system, an electronic transaction management system, or third party sources in order to reduce the amount of information a user or agent of the user enters to obtain advice.

There are many variations on how a forms and disclosures advice system may obtain information about a transaction from an agent and/or various databases in order to provide advice. The following figures show embodiments of interfaces for obtaining real estate information and/or for providing advice, but the present invention is not limited to these embodiments or to this particular application.

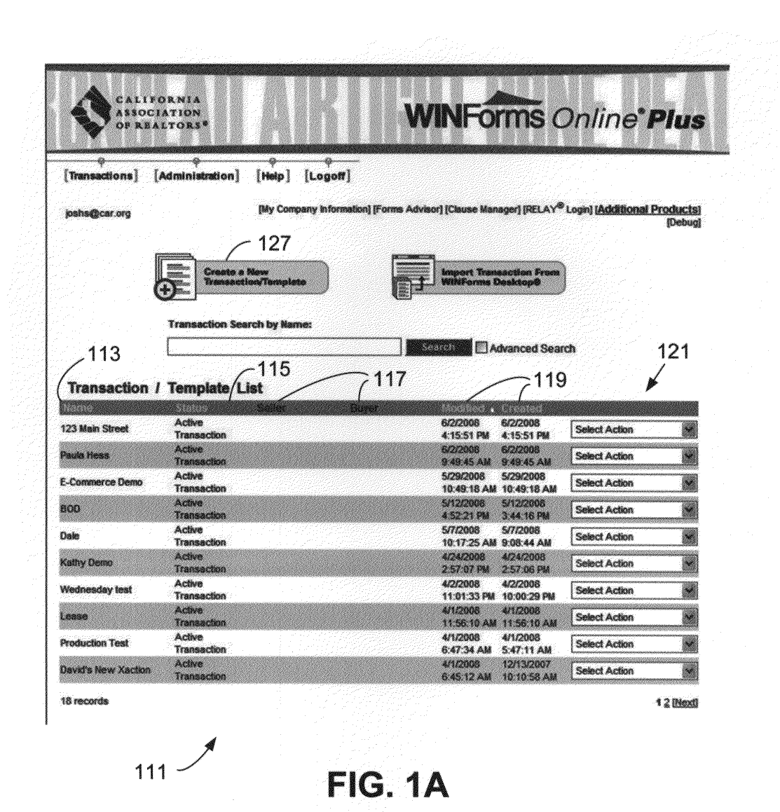

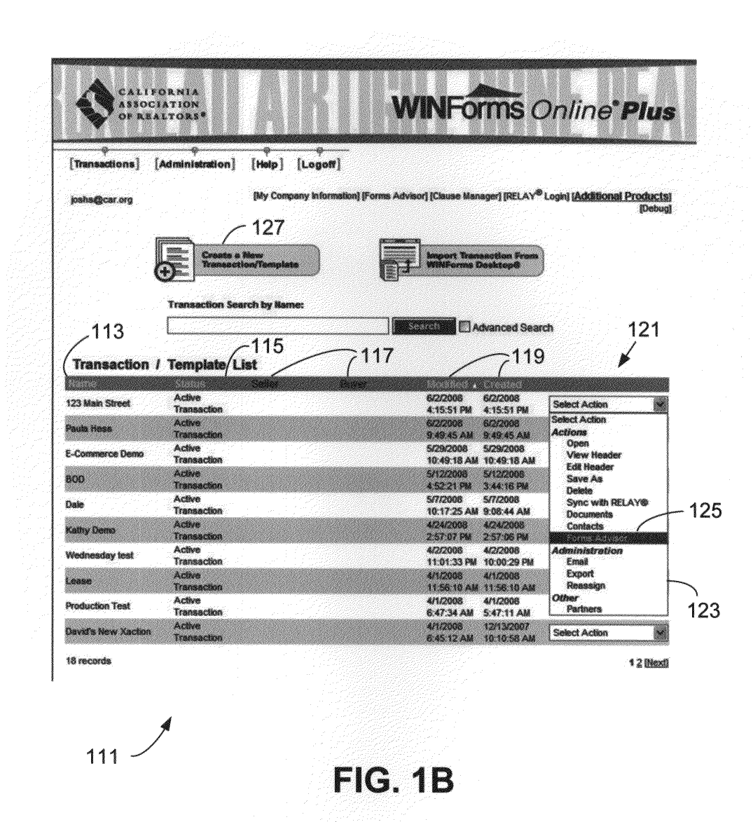

FIGS. 1A and 1B are screenshots of an exemplary product into which the forms and disclosures advice system may be integrated into a real estate application. FIGS. 1A and 1B show a screenshot of WINForms Online®, an organizational tool for, for example, real estate transactions. Another example of a real estate organizational product or tool with which the real estate forms and disclosures advice system may be integrated is ZipForm Online®. Additionally, other real estate tools, or other programs or products used in accordance with other fields or industries, may incorporate a similar forms and disclosures advice system based on each system's application.

The screenshots of FIGS. 1A and 1B include a transaction list 111 including a plurality of real estate transactions and templates. The transaction listing may include information on, for example, a name of a transaction or property 113, a status of the transaction 115, seller and buyer information 117, file modification information 119, and/or actions which may be taken with respect to each transaction 121. In some embodiments, different possible actions which may be taken with respect to each transaction may be arranged in a drop down menu. As is illustrated in FIG. 1B, a drop down menu 123 has been activated for the transaction “123 Main Street,” with a listing of possible actions and options available for selection. As seen in FIG. 1B, the drop down menu includes an option 125 to enter into the “Forms Advisor,” which in this embodiment is the name of the forms and disclosures advice system. Selection of the “Forms Advisor” option may direct users to a forms and disclosures advice session pertaining to the particular transaction. Other embodiments may include different associated names. Additionally, in FIGS. 1A and 1B, a “Create a New Transaction/Template” button 127 near the top of the user interface initiates an interface for creating a new transaction in the forms and disclosures advice system.

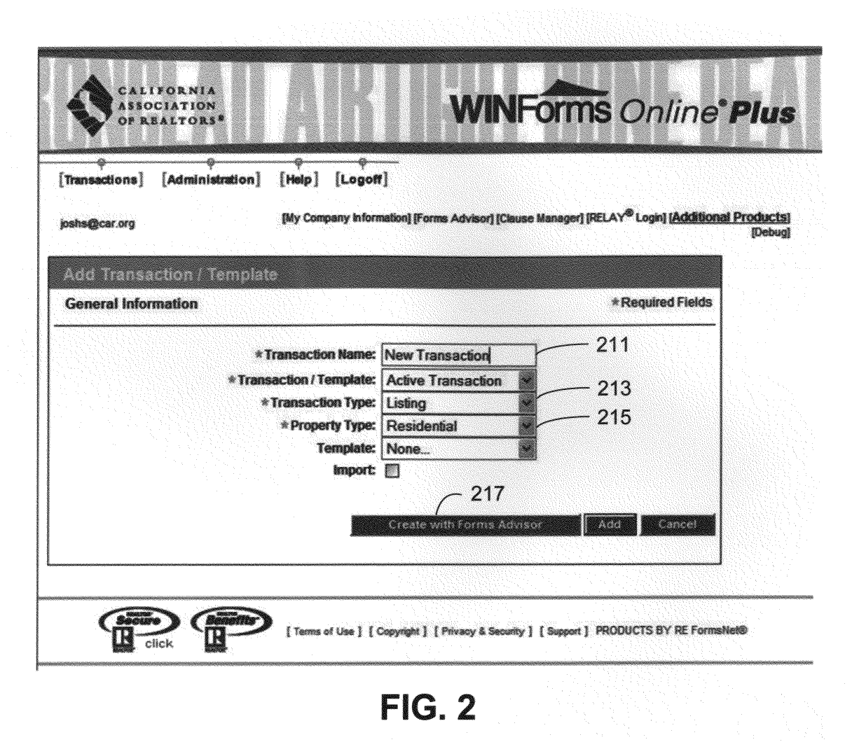

When a user selects the “Create a New Transaction/Template” option illustrated in FIGS. 1A and 1B, the user may be provided with a new transaction screen, for example, the new transaction screen illustrated in FIG. 2. The new transaction screen illustrated in FIG. 2 includes various questions. For example, questions may be provided regarding a transaction name 121, a transaction type 213, a property type 215, and/or other potentially useful information. Other embodiments of a new transaction screen may include different fields based on the particular application.

The new transaction screen of FIG. 2 is provided to users for creating a new transaction in the forms and disclosures advice system. Upon entry of the above described information, a user may select the “Create with Forms Advisor” button 217 at the bottom of the new transaction screen to apply the forms and disclosures advice system to the new transaction. In some embodiments, the information entered in the new transaction screen may be stored in a database and may be used to, for example, identify or retrieve the transaction at a later time. In some embodiments, the information entered in the new transaction screen may determine or modify later questions or fields asked in the forms and disclosures advice system, for example, which of a collection of different questionnaires to present to the user.

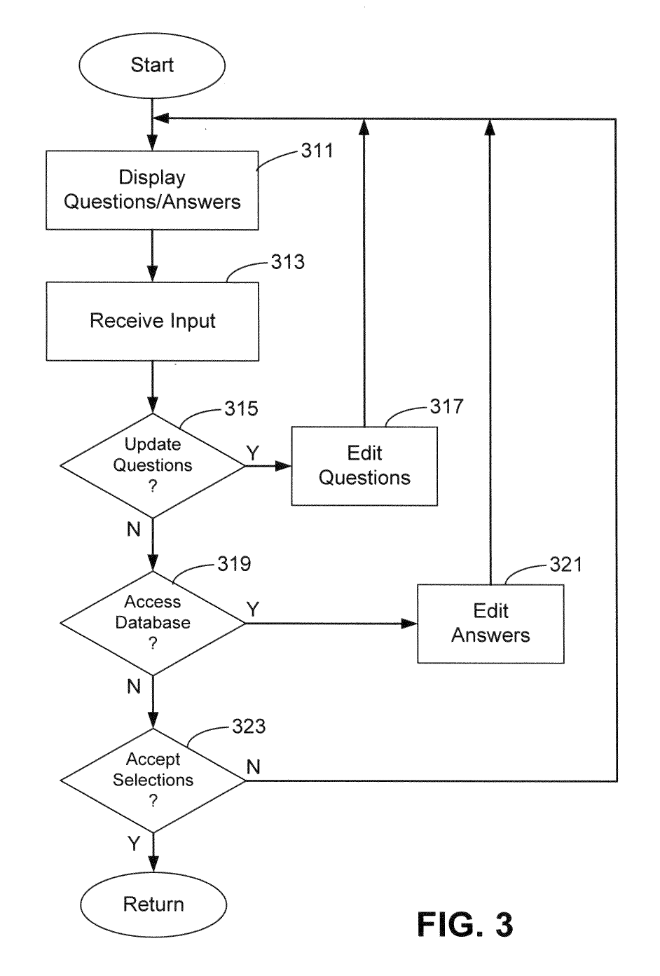

FIG. 3 is a flow diagram illustrating a typical operation process of an exemplary embodiment of the forms and disclosures advice system. Generally, the forms and disclosures advice system provides users with a number of questions, and recommends different forms, disclosures, and courses of action, among other types of advice, based on the user answers to the provided questions. In some embodiments, the forms and disclosures advice system may receive different types of inputs for each transaction, for example, both user answers and answers retrieved from various databases for provided questions.

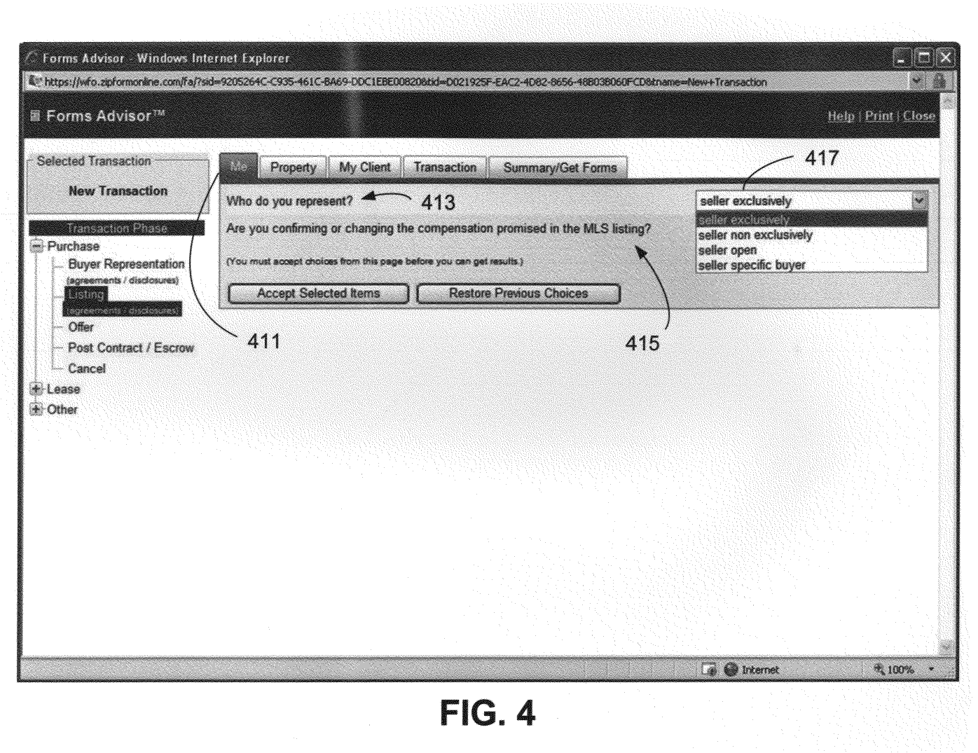

In block 311, the process displays questions, and in some cases, answers, for example, in fields which were automatically filled in or which were answered from a previous session. Various screenshots of examples of different question and answer displays in an exemplary embodiment of the present invention are provided in the following FIGS. 4-8.

In block 313, the process receives an input. The input may be, for example, a user-defined answer to a presented question, a selection from a drop down menu of potential answers, or an answer retrieved from the MLS or other similar database. In some embodiments, certain user-defined answers may cause the process to modify other related questions. In some embodiments, certain user-defined answers or selections from drop down menus may cause the process to access a database or databases to provide appropriate answers for related questions.

In block 315, the process determines whether to update the questions to ask the user. As mentioned above with respect to block 313, certain answers may lead the process to modify subsequent questions asked to the user. For example, an identification of the user as a buyer may lead to a different line of questioning than an identification of the user as a seller. If the process determines to update specific questions based on a user-defined input, the process proceeds to block 317, where the process edits the appropriate questionnaires based on the user-defined input. The process then returns to block 311, where the new set of questions and answers is displayed. If the process determines not to update specific questions based on a user-defined input, the process proceeds to block 319.

In block 319, the process determines whether to access one or more databases for additional information based on a supplied input. For example, if a user provides an address to a particular property which one or more databases stores information about, the process may retrieve such information from the appropriate database or databases. In some embodiments, the process may then auto-complete some related answers, assisting the user in filling out a questionnaire more quickly and efficiently. In other embodiments, the process may use the information to partially or completely fill out selected forms after a forms selection process is conducted. If the process determines that additional information should be accessed from a database, the process proceeds to block 321, where information retrieved from the database is entered into appropriate answer fields. The process then returns to block 311, where information from the database is updated and displayed in the specified answer fields. If the process determines not to access additional databases, the process proceeds to block 323.

In block 323, the process determines whether to accept the answers and selections the user and/or databases have provided to the forms and disclosures advice system. If the selections are not accepted, for example, if a questionnaire has yet to be completed, or if the user wishes to modify one or more answers, the process returns to block 311, where the user is again provided with the set of questions and completed answers. If the selections are accepted, the process returns. In some embodiments, incomplete or partially completed questionnaires may be accepted and saved. For example, if a particular questionnaire is partially completed, and the user proceeds to a different questionnaire, some embodiments may auto-save the provided responses in the incomplete questionnaire, such that the user may return to the questionnaire and continue filling it out at a later time. In some embodiments, select forms, disclosures, and/or advice may be later provided based on partially completed questionnaires. For example, utilization of particular forms may be predicated on particular questions in the questionnaire. If such questions have already been completed, the forms and advisor system may be configured to recommend corresponding forms based on those completed questions, even if other portions of the questionnaire may be incomplete.

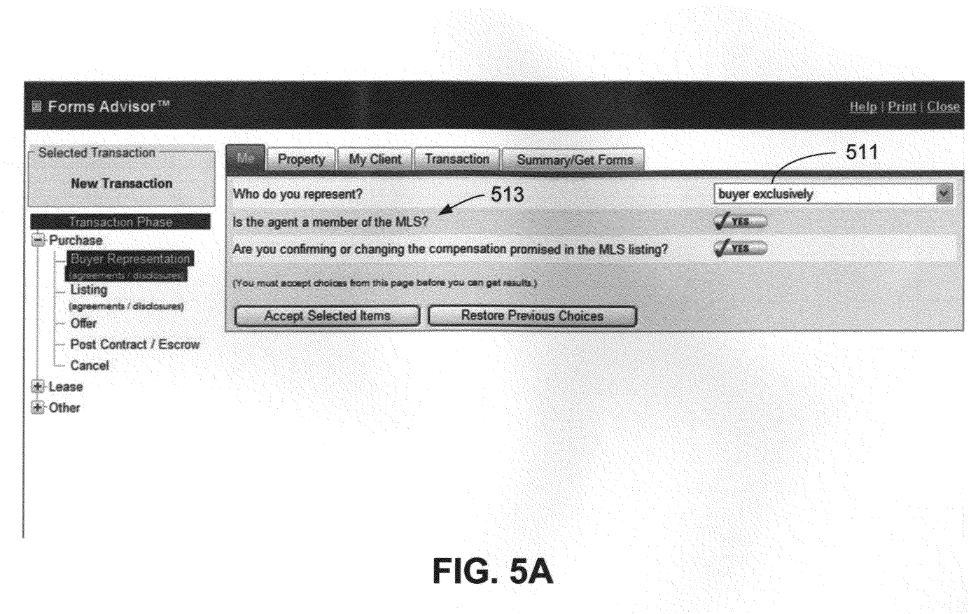

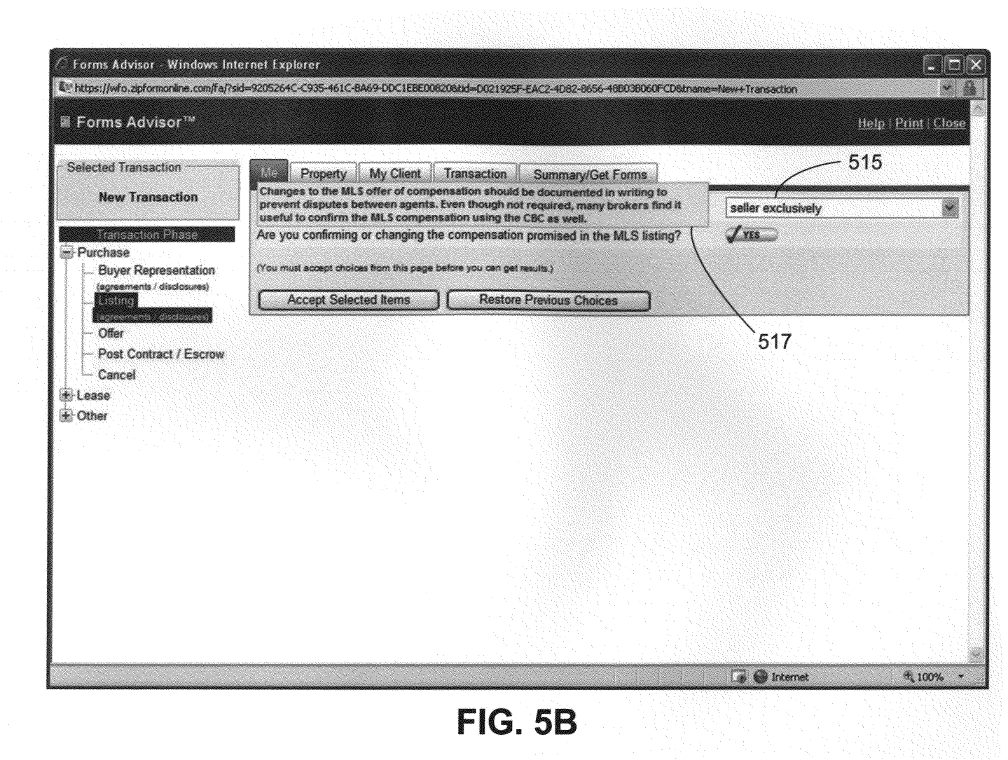

FIGS. 4, 5A, and 5B illustrate an introductory screenshot of a real estate purchase questionnaire in a forms and disclosures advice system in accordance with aspects of the invention. In the screenshots of FIGS. 4, 5A, and 5B, the “Me” tab 411 is active atop the display, indicating that the questions are related to the user. The screenshots include, for example, information about the representative capacity of the user 413, and additional user related question or questions 415.

The screenshot of FIG. 4 includes an inquiry, including a drop down menu 417, as to who the user is or represents. The embodiment of FIG. 4 includes different seller options, but may in other embodiments include buyer options and/or other representative capacities as well. Each embodiment may include a different set of applicable representative capacities. In some embodiments, the advice system may be context-aware, that is, adjust selection language based on the application or context in which the advice system is being utilized. The screenshot of FIG. 5A illustrates an exemplary screenshot when the user indicates that he is or represents the buyer 511. The display is modified to include an additional question 513 due to the indication that the user is a buyer representative, namely, whether the user is an agent or a member of the MLS. By contrast, in FIG. 5B, the user identifies himself as the seller or a representative of the seller 515. In the screenshot of FIG. 5B, the question described with respect to FIG. 5A above is not presented to the user. Furthermore, other questions associated with other display screens may be modified as well.

In some embodiments, the display may include, for example, tool tips in the form of pop-up advice or information 517 for appropriately filling out particular fields. Such pop-up information may be available, for example, if the user right clicks and asks for additional information, or in some embodiments may appear when a user hovers a cursor over the associated question.

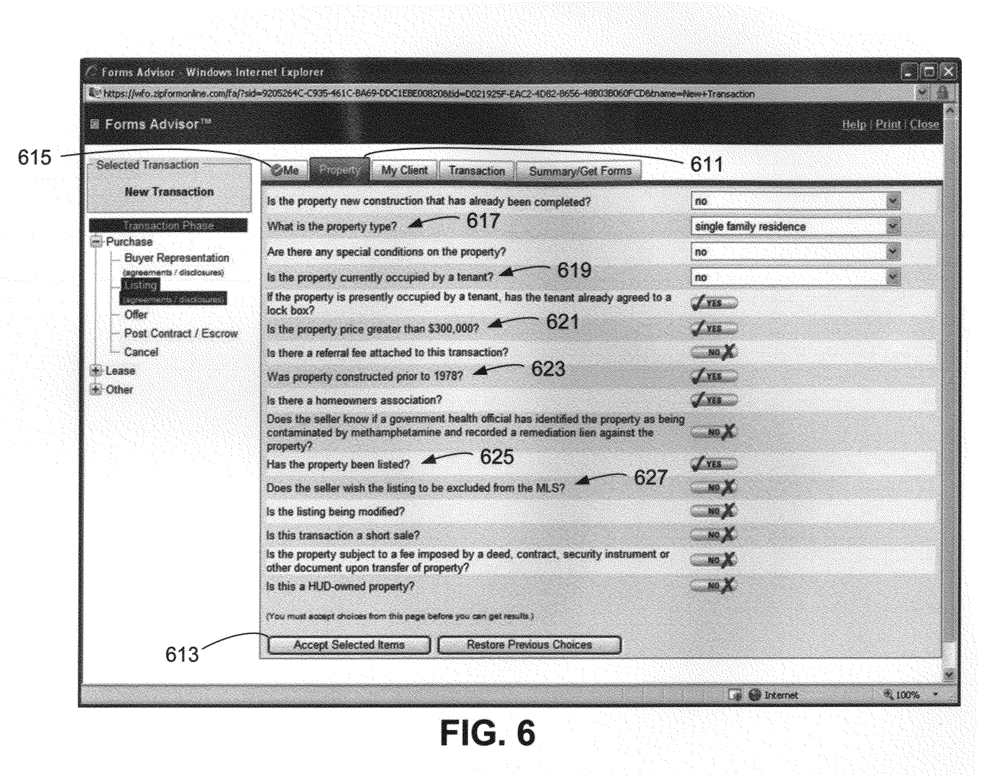

FIG. 6 is a screen/panel showing questions associated with general property information about a real estate transaction. This is indicated by the active “Property” tab 611 at the top of the display. In some embodiments, access to the different display panels may be provided when the user selects a particular panel to display, for example, when a user selects a desired tab with a cursor. In some embodiments, completion of the questions on a particular display panel or questionnaire, and a subsequent selection of the “accept selected items” button 613 near the bottom of the display, may cause the forms and disclosures advice system to display a subsequent display panel. In some embodiments, a completed display panel may also be identified, for example, with a visual checkmark 615 on the associated tab. In some embodiments, a saving option may be available for users to save partially or fully completed questionnaires, and return later to continue or modify answers. Some embodiments of the present invention may further include an auto-save function.

In the property information display panel of FIG. 6, classes of information may include, for example, types of property, use and intended use of property, and phase of transaction, among other types of information. Other embodiments may include different information based on the application of each particular embodiment. As depicted in FIG. 6, the display includes a plurality of questions requesting user selections related to a particular transaction. Questions may be related to, for example, property type 617, current occupation status of the property 619, property value 621, construction date 623, listing status 625, MLS status 627, and other similar questions. The display may include additional user questions and selections to define the disclosures and forms associated with the particular transaction. As discussed above, in some instances, answers to a particular question may serve to modify particular related questions.

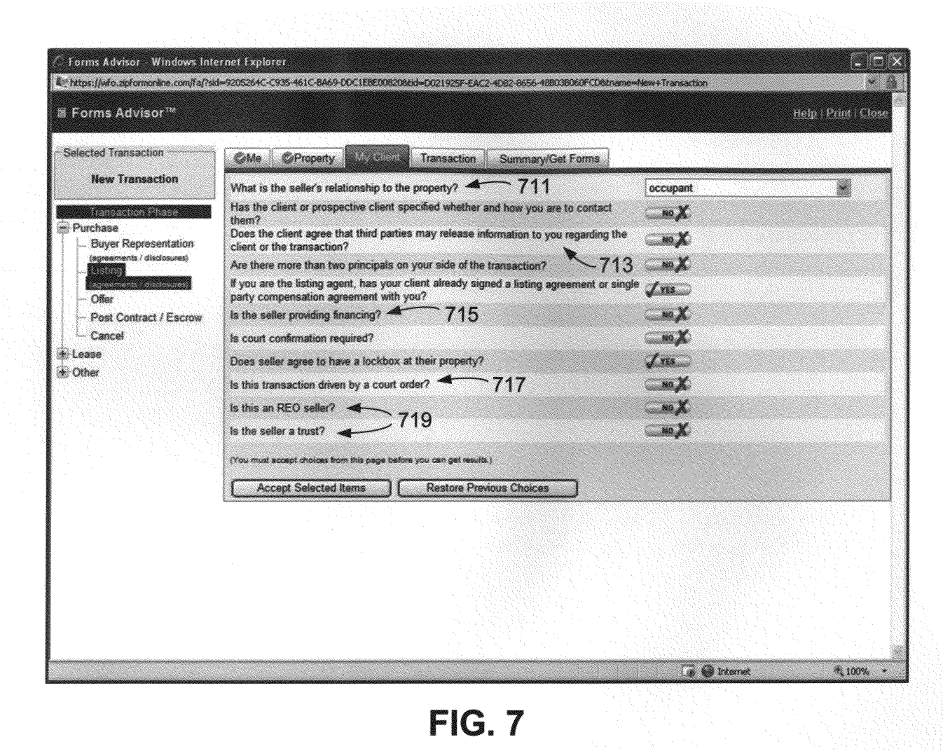

FIG. 7 is a screen/panel showing questions and user answers to client related information regarding a real estate transaction. The display may include a plurality of questions and user selections related to the client, for example, seller status 711, methods of communication 713, financing information 715, court involvement 717, and seller information 719, among other questions. The display may include additional and/or different user questions and selections to define the disclosures and forms associated with the particular transaction.

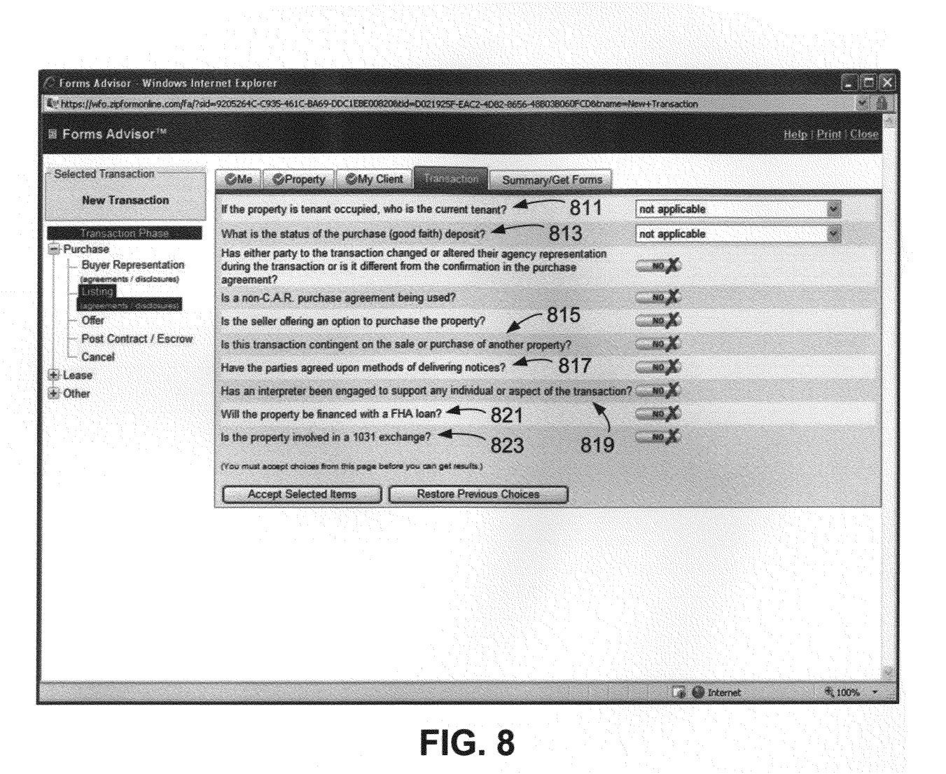

FIG. 8 is a screen/panel showing questions and user answers to transactional information regarding a real estate transaction. The display may include a plurality of questions and user selections related to a particular real estate transaction. Examples of some questions may involve the current tenant 811, deposit information 813, related property transactions 815, communication agreements 817, interpreter information 819, FHA loans 821, and 1031 exchanges 823. As with the other display screens, additional and/or alternate questions may also be provided.

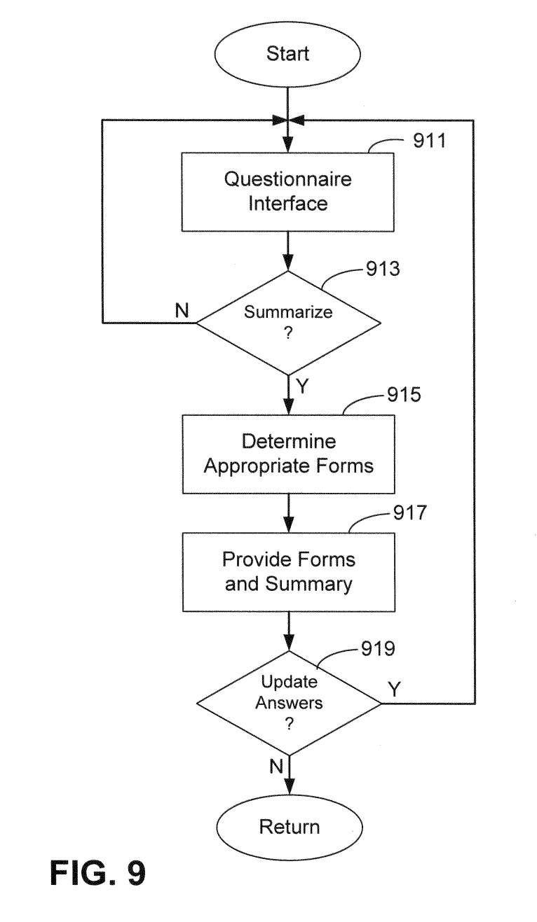

After a questionnaire or set of questionnaires are completed, the user has the option of requesting a summary suggesting specific forms and disclosures to use, as well as different types of advice on using those forms and disclosures. FIG. 9 is a flow diagram of a process of determining the appropriate forms to use for a particular transaction in accordance with aspects of the invention. Generally, the forms and disclosures advice system compiles the information and determines the appropriate forms and disclosures to use based on the answers to the questionnaires and on current applicable laws and/or ordinances. In some instances, forms may also be recommended based on, for example, best practices or common practices of a particular profession. In some embodiments, summaries may also be requested even if some questionnaires are only partially completed. In these embodiments, the process may perform a topological sort, whereby specific answers to selected questions may be adequate to determine particular forms or disclosures to use. In some of these embodiments, such forms summaries may be accompanied by, for example, a warning that not enough information has been provided to reach a comprehensive assessment of the required and/or recommended forms, or for example, recommendations on the most conservative approach to take, that is, erring on the side of inclusion of forms in situations where not enough information has been provided regarding selection of those form.

In block 911, the process is in the questionnaire interface. Block 911 may represent the process as described with respect to FIG. 3, where a user and/or one or more databases provide inputs to different questions regarding a specific transaction.

In block 913, the process determines whether to summarize a set of results, that is, provide advice and recommendations on forms and disclosures to use, based on the information provided in the questionnaire interface described with respect to previous figures. In some embodiments, the process may determine to summarize results when a user selects a summarize option in another display panel. In some embodiments, the process may determine to summarize results when a “Summary” tab is selected in a user interface. If the process determines not to summarize the results, the process returns to the questionnaire interface of block 911. If the process determines to summarize the results, the process proceeds to block 915.

In block 915, the process determines the appropriate forms and/or disclosures to use. The process may involve accessing algorithms which match answers to questionnaires with rules sets related to the transaction. In this respect, rules sets may include, for example, business logic processing rules for programmers, and in some cases, knowledge experts and/or business analysts to provide information, updates, or other different types of input. Rules sets may also include, for example, user interface rules which may establish a more easily understandable end product for users to access and interact with. In some embodiments, the forms and disclosures advice system may associate each of the answers to the questionnaires with a variable. The process may determine which forms and disclosures are appropriate for the particular transaction by iterating through a set of rules which are a function of the variables. In an exemplary embodiment, the system determines which forms and disclosures are needed for a particular stage or phase in the transaction as defined by the answers and inputs, as the appropriate forms and disclosures differ depending on the particular stage of the transaction. The forms and disclosures may be selected from a database or memory including different forms and disclosures available from, for example, the federal government, state governments, counties, municipalities, and the brokers themselves, among other sources. In some embodiments, the rules sets may be updated periodically to conform to the most recent law or ordinance changes. In some of these embodiments, updates may be applied automatically through a central database connected to a particular forms and disclosures advice system, or may be applied by a user through, for example, a user prompt or a downloadable file.

In many embodiments, the rules sets may be defined and/or modified using a number of different knowledge or information sources and tools. In some instances, a Business Rules Management System may be established, such that each source of knowledge or information may have different roles and responsibilities in defining and/or modifying the rules sets in a more efficient and effective manner. For example, programmers may develop modeling tools which easily apply business logic processing rules to a user interface. Knowledge experts, such as attorneys, may provide information for establishing a framework of specific requirements in certain situations based on, for example, prevailing federal, state, or local laws. Business analysts may supply input pertaining to specific business rules or common or best practices in a particular field, such as real estate, and may also provide management or company specific rules, in some instances enhancing, building upon, and/or overriding an initial rules set framework.

Programmers may provide a knowledge expert friendly and/or business analyst friendly modeling tool to collect input pertaining to, for example, changes in applicable laws, newly developed forms or disclosures, or modified best practices. Alternatively, the programmers may work together with the knowledge experts or business analysts to continually compile information and update the rules sets accordingly. In this manner, user interfaces may continually be updated based on the most current or most recently updated rules sets. The dynamic nature of such a Business Rules Management System may provide for an infinitely malleable forms and disclosures advice system.

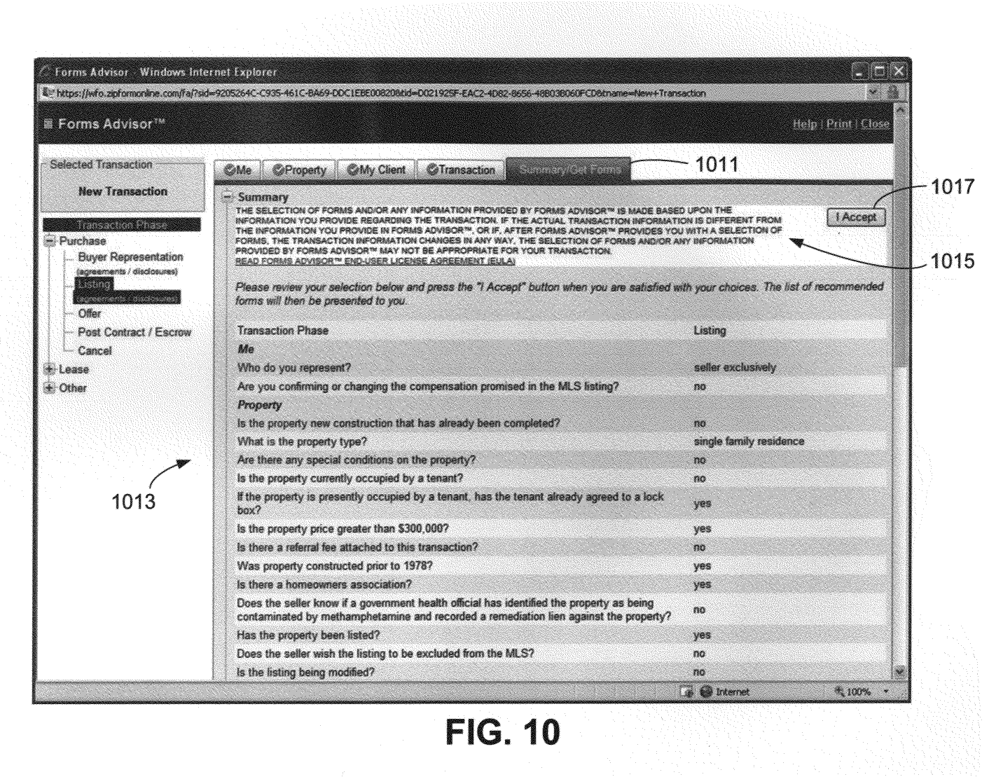

In block 917, the process provides a summary of the selected forms and disclosures, as well as any available advice and/or recommendations, to the user. Different examples of summary pages may be found, for example, in the screenshots provided in FIGS. 10-12 below. In some embodiments, the summaries may include compiled summaries of different inputted answers, selected or recommended forms, and any advice or potential warnings to be aware of when completing some of the selected forms. Some embodiments may also include more comprehensive information on each form, for example, form previews and/or detailed instructions. Suggested forms may be time-specific, for example, suggesting a first set of forms appropriate for initiating a transaction, and at a later time, suggesting a second set of forms appropriate for, for example, finalizing the same transaction.

In block 919, the process determines whether answers have been updated. Even after a summary has been requested by the user, in most embodiments, the user may decide to return to any of the previous questionnaires to edit, modify, add, or delete one or more answers to presented questions. Such answer updates may also result in updates or changes to the recommended forms and disclosures in the summary. If the process determines whether answers have been updated, or whether the user has requested to update any answers, the process returns to the questionnaire interface represented by block 911. If the process instead determines that answers have not been updated, either through a confirmation by the user, or inaction by the user, the process keeps the selected summary of forms, disclosures, and suggested advice, and returns.

FIG. 10 is an example of a screenshot of a first summary page in accordance with aspects of the invention. The summary section is active, as indicated by the highlighted tab 1011 at the top of the interface. A first screen may be provided to summarize 1013 user and/or database inputs and responses to the questionnaires. Furthermore, disclaimers 1015, for example, to disclaim that the provided information serve as recommendations rather than legal advice, or for example, end-user license agreements, may be presented to the user to review. The user may be prompted 1017 to read and/or accept the disclaimer prior to receiving the selected forms, disclosures, and applicable advice.

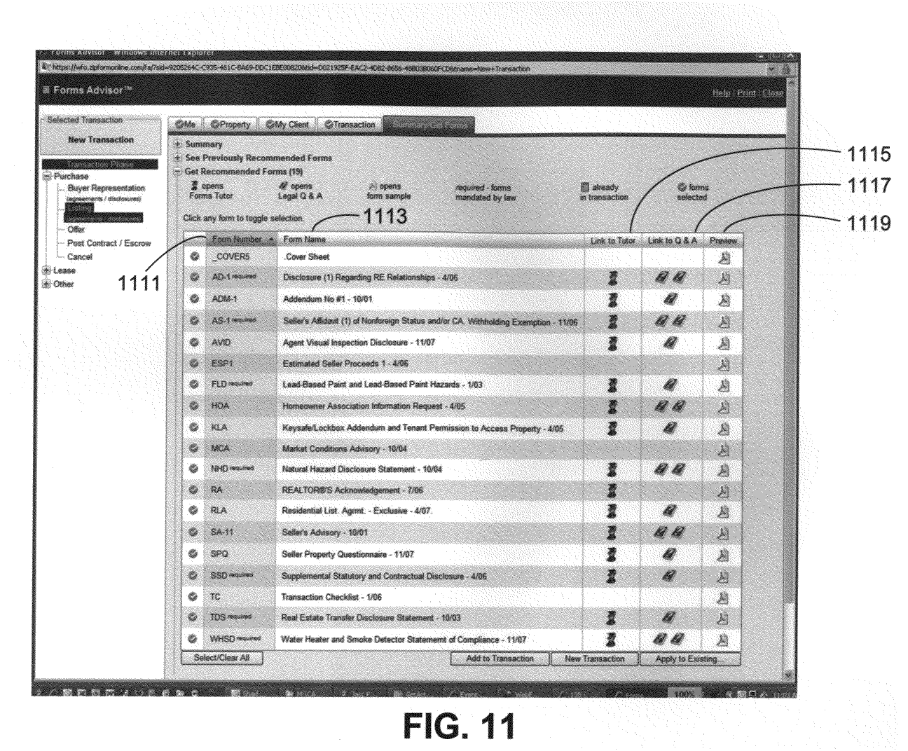

FIG. 11 is an example of a screen/panel summarizing advice provided as a result of the answers and other information provided in the questionnaires. As described above with respect to FIG. 9, the forms and disclosures advice system may set variables depending on each of the user inputs in the questionnaires. The variables may be inputted into one or more sets of rules, which may define which of the forms and disclosures are needed for the particular transaction. As illustrated in FIG. 11, the display screen may include information on selected forms and disclosures, for example, form numbers 1111, form names 1113, links to form tutors or instructions 1115, links to frequently asked questions (FAQs) and/or answers 1117, and form previews 1119. Some of the provided information, for example, the help, FAQ, and preview links may link the user to an external system that may provide the form/disclosure, information on filling out the form/disclosure, information on what stage in the transaction to use the form/disclosure, or other information related to the particular form/disclosure that may be informative to a user, such as tutorials related to the type of transaction. The display screen may further include additional information to inform an agent or other user of the system about the selected forms, disclosures, or types of transactions or other applications, for example, e-commerce links to potentially helpful products associated with particular summary results. In some embodiments, forms may be downloadable, and may be partially filled out or completed in accordance with inputs and information supplied in the questionnaires.

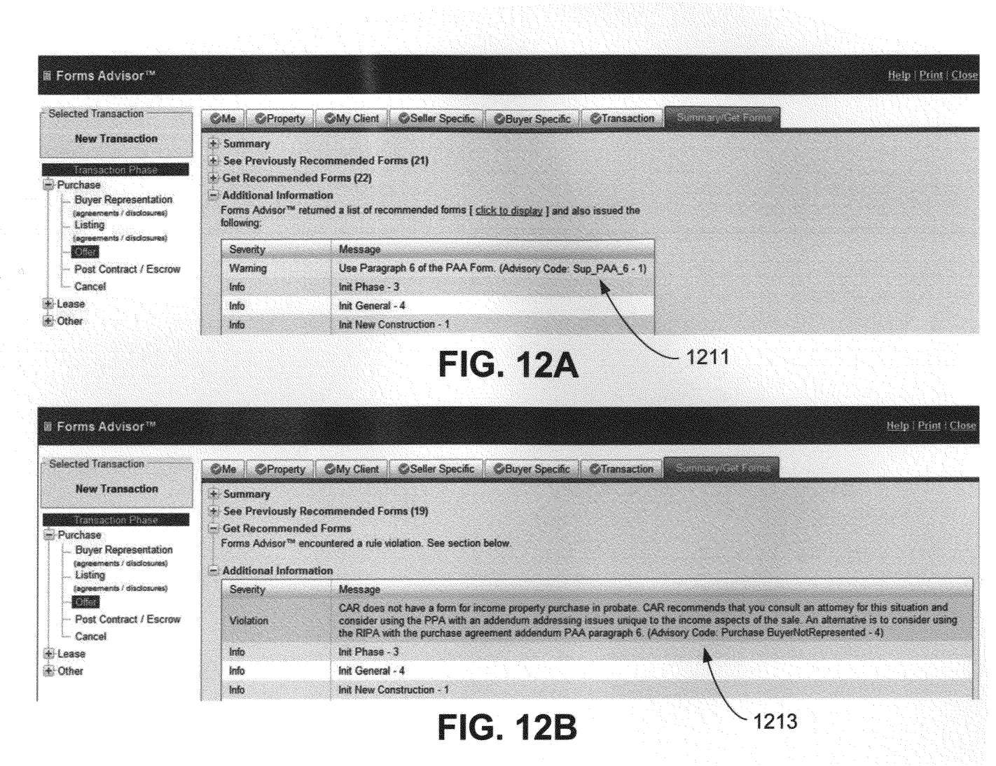

FIGS. 12A and 12B illustrate examples of different notifications which may be associated with particular forms selected by the forms and disclosures advice system. In FIG. 12A, a warning 1211 is provided by the system indicating that a particular paragraph of a form should be completed based on the previously provided answers or inputs. Such a warning may be designated by a “Warning” label, and/or may be shaded a different color than the other provided information or advice, for example, yellow. Other embodiments of the invention may identify warnings in a number of different ways. In FIG. 12B, a violation 1213 is indicated by the system, notifying the user that there is no form that meets the specific situation based on the provided user answers and inputs. In this situation, directive information may be provided to assist the user in determining how to proceed, for example, consulting an attorney for further guidance. In some embodiments, such violations may be designated by a “Violation” label, and also may be shaded a different color to attract attention to the violation, for example, red.

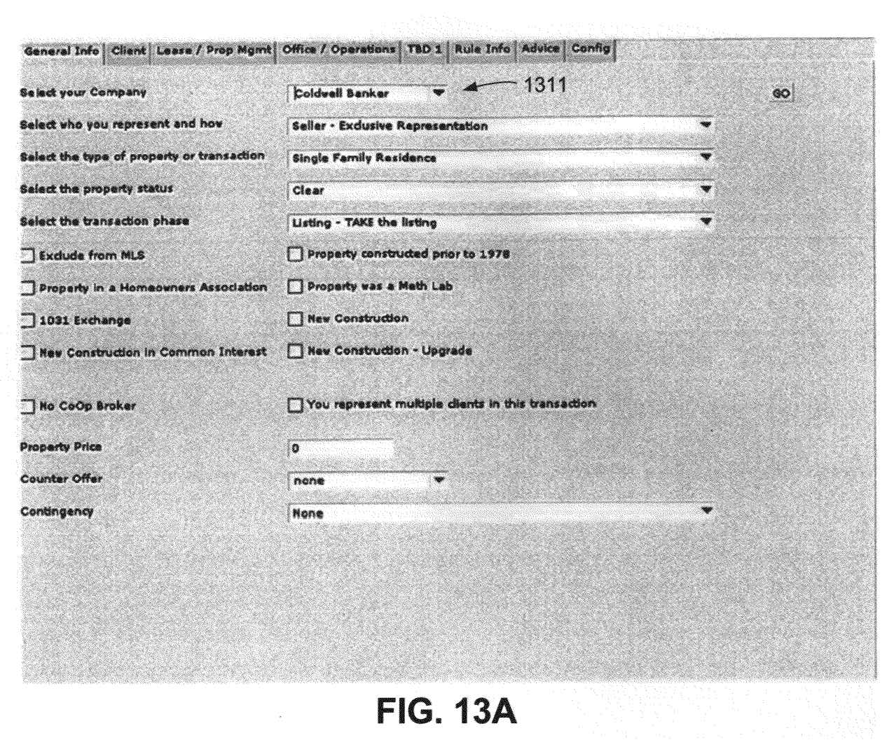

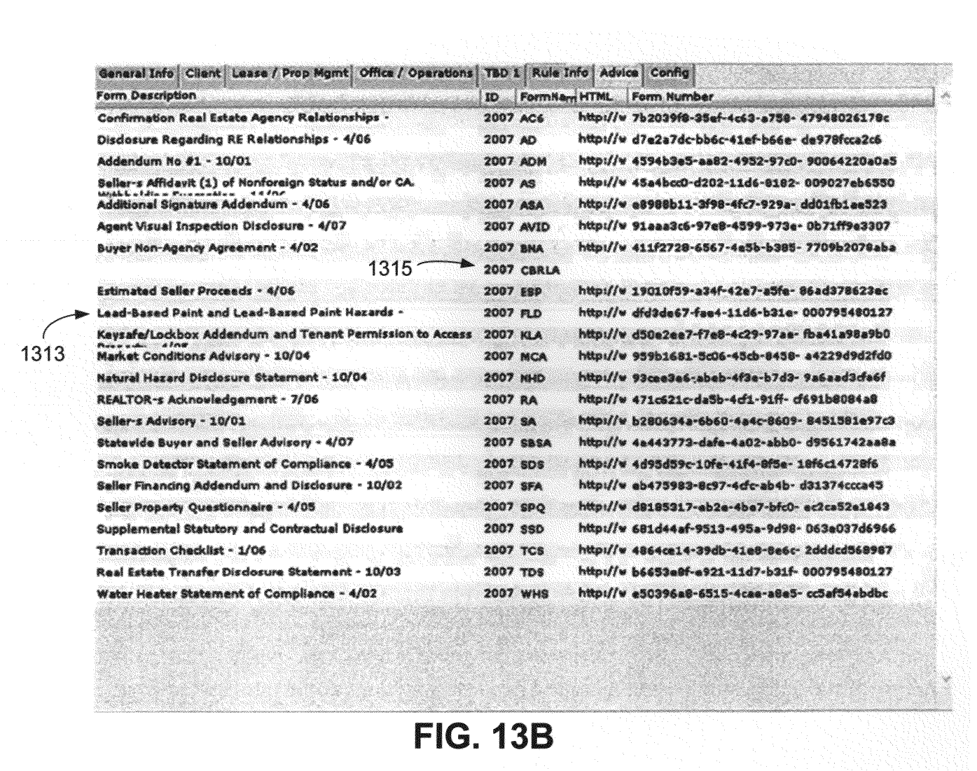

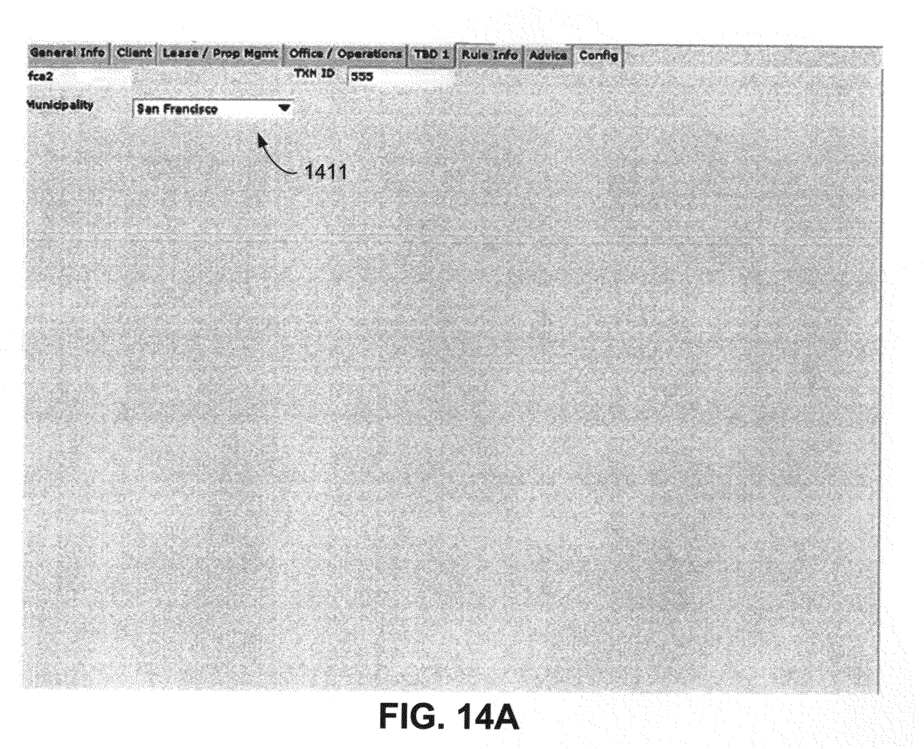

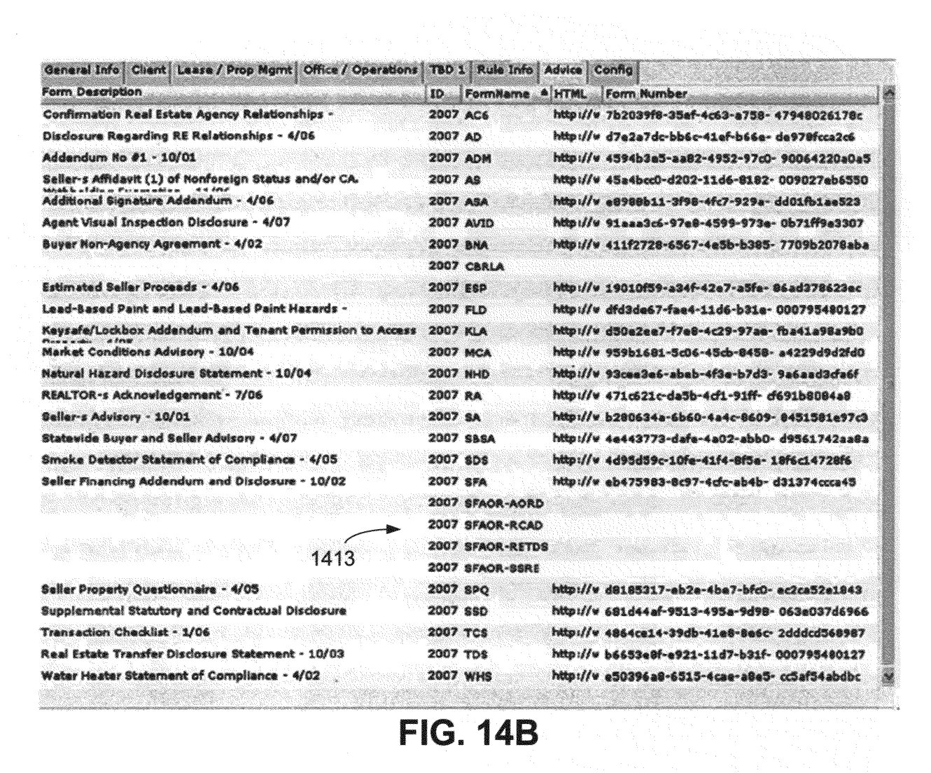

FIGS. 13A, 13B, 14A, and 14B illustrate a forms and disclosures advice system in accordance with a second embodiment of the present invention. The second embodiment of the present invention may be configured to resemble the embodiment described above with respect to the previous figures, in both appearance and questions presented to the user. As discussed above, the forms and disclosures advice system provides different forms, disclosures, and advice based on the inputs of the particular user. The second embodiment described with respect to FIGS. 13A, 13B, 14A, and 14B illustrates this dynamic nature of the advice system. For example, FIG. 13A is a screen/panel showing questions and user entries of general information about a transaction, for example, a real estate transaction. In the embodiment of FIG. 13A, a user may make a plurality of input selections, including company name 1311. If a particular company name is selected, for example, “Coldwell Banker,” the system may modify its advice consistent with certain practices of the company. For example, particular brokers may prefer additional forms/disclosures or custom forms be used in particular transactions. For example, a broker may prefer utilizing a lead-based paint disclosure on all properties, not just properties constructed prior to 1978. Thus, if a company is selected which adheres to such practice, the system may modify its advice to include the lead-based paint disclosure despite the year in which the property was built. Hence, the system offers flexibility to brokers to modify the advice provided by the system by allowing a particular broker to override advice provided to the agents of the broker.

FIG. 13B is a related screen/panel showing advice provided as a result of the user answers and information entered about the real estate transaction in FIG. 13A. By selecting “Coldwell Banker” as the company name that variable may be inputted into an applicable rule in a rules set associated with the company, defining which overrides to apply to the provided advice summary related to the forms and disclosures associated with the transaction. As illustrated in FIG. 13B, the display screen further includes advice to use the lead-based paint and lead-based paint hazards disclosure 1313 and an additional Coldwell Banker custom form CBRLA 1315.

Some embodiments may provide a display showing information on the rules applied to provide the advice summary. As discussed above, each user input is associated with a variable, the variables are input into the rules, and the rules define which forms/disclosures should be used in a particular transaction. In some embodiments, the list of the rules that were triggered and the conditions that were satisfied may be available for the user to review.

FIG. 14A is another screen/panel showing additional configuration parameters that may affect the advice summary provided. As illustrated in FIG. 14A, a user may further input rules of a specific municipality 1411 to apply, which may further override advice provided by the system to include forms/disclosures associated with the particular municipality. For example, selecting San Francisco may cause the system to advise use of San Francisco related forms as depicted in FIG. 14B if rules are set directing the system to define a set of forms/disclosures for the San Francisco municipality.

FIG. 14B is a related screen/panel showing advice provided as a result of the user answers and information entered about the real estate transaction in FIG. 14A. As depicted in FIG. 14B, the summary display includes various forms and disclosures 1413 associated with the San Francisco municipality.

In summary, the forms and disclosures advice system provides advice about forms to use and disclosures to make. The advice varies depending on the application, for example, in a real estate transaction, the advice may be based on a phase or stage of the transaction, who the agent is representing, the location of the property, type of property, broker and/or agent, physical attributes of the property, and other property and transaction related information. In some embodiments, the forms and disclosures may be mandated by federal or state law or by local ordinance. In some of these embodiments, the system may allow for overrides by local associations and brokers who may, for example, want their agents to use non-mandatory or customized forms and disclosures.

The system may generate advice by modifying associated variables with user inputs and iterating through rules sets that are a function of the variables. For example, as discussed above, a rules set may be previously defined and/or modified by knowledge experts (e.g., attorneys) and/or field specific business analysts. Having a rules-based framework allows the system to be easily modified with new rules sets based on, for example, new laws at the federal, state, or local levels, or for example, updated best or common practices of the specific field. The system may consider upwards of 10⁷⁰ different possible conditions in evaluating which forms to advise. For example, the California Association of Realtors alone provides more than 150 proprietary forms which may be applicable or useful for different real estate transactions in the state of California. The number of conditions may be a function of the number of rules applied (for example, there are currently more than 500 California rules), variables, and forms, such that the number of different possible conditions will vary as the number of applied rules, variables, and forms vary.

The system may also provide forms and disclosures related to leases, property management, office management, office operations, employee and contracting agreements, trust accounting, and other transactions which may utilize particular forms and disclosures. The system may also retrieve the proper forms and disclosures and fill out parts of the forms and disclosures to help facilitate and expedite the transaction process. If no forms or limited forms are available for a particular transaction, the system provides guidance or recommendations to the user, for example, to seek legal counsel in situations where forms may not be available. In addition, the system may provide additional information associated with each advised form or disclosure, such as legal recommendations, tutorials, guidance instructions in filling out the form or disclosure, and educational instruction associated with the particular form or disclosure or associated with the real estate transaction. Furthermore, the system may obtain at least some of the information about the property and the real estate transaction from an MLS, public record databases, electronic forms systems, electronic transaction management systems, or various third party sources in order to reduce the amount of answers or information a user enters.

By providing standardized advice on forms and disclosures, the system promulgates proper usage of the forms and disclosures, and may help to protect buyers, sellers, and their agents from liability for failure to use the proper forms and disclosures as mandated by federal and state laws.

In another exemplary embodiment, the system may integrate results with an electronic forms solution. The system may do the following: (1) automatically build a transaction with the forms recommended by the system; (2) compare and contrast the forms recommended by the system with the forms presently in the electronic forms solution; and (3) provide the user with the option to add all of the recommended forms or a subset of the forms to the transaction.

In yet another exemplary embodiment, (1) the system may maintain an audit trail of the inputs provided by the user and the advice that the system provides; (2) when a form for a particular set of inputs is not available, the system may provide notice of that fact, and/or instructions to contact an attorney with suggestions of what needs to be done for that transaction; (3) the system may maintain a copy of the form image in the audit trail to save and store a sample specimen available for later access and or investigation; (4) the system may advise who the parties are to the form (i.e., whether the form is used between agent and customer, agent and broker, agent worksheet, one side of the transaction to the other, etc.); and (5) the system may mine information from filled-in fields on forms in the electronic forms solution (for example, the system may extract the sales price from a related form or cover sheet if the user has already entered the sales price on the related form or cover sheet, so that the user does not need to enter the sales price again in the forms and disclosures advice system).

While the invention has been described in terms of exemplary embodiments, it is to be understood that the words which have been used are words of description and not of limitation. As is understood by persons of ordinary skill in the art, a variety of modifications and equivalent arrangements may be made without departing from the spirit and scope of the invention defined by the following claims, which should be given their fullest scope.

What is claimed is:

1. A method for providing advice on selecting and completing forms and disclosures, comprising:
collecting information from a user;
selecting forms and disclosures based on a plurality of rules and the information collected; and
providing advice on the selected forms and disclosures.

2. The method as claimed in claim 1, further comprising overriding at least one rule of the plurality of rules.

3. The method as claimed in claim 1, wherein the selecting forms and disclosures comprises:
setting variables associated with the information collected; and
processing the plurality of rules as a function of the variables to determine appropriate forms and disclosures to select.

4. The method as claimed in claim 1, further comprising providing instructions on the selected forms and disclosures.

5. The method as claimed in claim 1, further comprising providing the selected forms and disclosures for download.

6. The method as claimed in claim 5, further comprising filling out portions of the downloadable forms and disclosures in accordance with the information collected.

7. The method as claimed in claim 1, further comprising providing previews of the selected forms and disclosures.

8. The method as claimed in claim 1, wherein the plurality of rules are based on at least one of federal laws, state laws, local ordinances, or a set of best or common practices.

9. The method as claimed in claim 8, wherein the plurality of rules are updated in accordance with updates to the at least one of federal laws, state laws, local ordinances, or set of best or common practices.

10. The method as claimed in claim 1, wherein the collecting information from a user includes collecting a portion of the information at a first time, and collecting a remaining portion of the information at at least one additional time subsequent to the first time.

11. The method as claimed in claim 1, wherein the collecting information, the selecting forms and disclosures, and the providing advice correspond to a particular transaction.

12. The method as claimed in claim 11, wherein the providing advice includes providing a list of the selected forms and disclosures for a particular stage of the particular transaction.

13. The method as claimed in claim 11, further comprising obtaining information related to the particular transaction from at least one of a multiple listing service, a public record database, an electronic forms system, an electronic transaction management system, or one or more third party sources.

14. The method as claimed in claim 11, wherein a first group of the selected forms and disclosures is presented to the user at a first stage of the particular transaction, and at least one additional group of the selected forms and disclosures is presented to the user at at least one later stage of the particular transaction.

15. The method as claimed in claim 11, wherein the particular transaction is a real estate transaction.

16. A method for providing advice on real estate forms and disclosures for a real estate transaction, comprising:
obtaining information related to the real estate transaction from a multiple listing service, a public record database, an electronic forms system, an electronic transaction management system, or one or more third party sources;
collecting information related to the real estate transaction from a user;
processing a plurality of rules in accordance with the obtained and collected information to determine appropriate real estate forms and disclosures to select for the transaction from a plurality of real estate forms and disclosures from at least one of the federal government, state governments, local municipalities, brokers, or at least one of the one or more third party sources;
providing a list of the selected real estate forms and disclosures for the real estate transaction;
providing the selected real estate forms and disclosures for the real estate transaction for download; and
automatically filling out portions of the downloadable real estate forms or disclosures in accordance with the obtained and collected information.

17. A system for providing advice on selecting and completing forms and disclosures, the system comprising a memory including program instructions and a processor, the processor configured by the program instructions to:
collect information from a user;
select forms and disclosures based on a plurality of rules and the information collected; and
provide advice on the selected forms and disclosures.

18. The system as claimed in claim 17, wherein the collected information, the selected forms and disclosures, and the provided advice relate to a real estate transaction.

19. The system as claimed in claim 17, wherein the processor is further configured by the program instructions to obtain information from at least one of a multiple listing service, a public record database, an electronic forms system, an electronic transaction management system, or one or more third party sources.

20. The system as claimed in claim 17, wherein the plurality of rules are based on at least one of federal laws, state laws, local ordinances, third party sources, or a set of best or common practices, and wherein the plurality of rules are updated in accordance with updates to the at least one of federal laws, state laws, local ordinances, third party sources, or set of best or common practices.
